(19) United States
(12) Patent Application Publication
(10) Pub. No.: US 2026/0297219 A1
(43) Pub. Date: Oct. 1, 2026

(54) PROCESS OF STARTING UP A GAS PHASE OLEFIN POLYMERIZATION REACTION

(71) Applicant: Basell Polyolefine GmbH, Wesseling (DE)

(72) Inventors: Stefano Sessa, Ferrara (IT); Lorella Marturano, Ferrara (IT); Paolo Capisani, Ferrara (IT); Maria Di Diego, Ferrara (IT); Pietro Baita, Ferrara (IT); Ulf Schueller, Frankfurt/M (DE); Alberto Nardin, Ferrara (IT); Antonio Mazzucco, Ferrara (IT)

(73) Assignee: Basell Polyolefine GmbH, Wesseling (DE)

(21) Appl. No.: 19/484,234

(22) PCT Filed: May 22, 2024
(86) PCT No.: PCT/EP2024/064076

§ 371 Date: Nov. 13, 2025

(30) Foreign Application Priority Data
May 22, 2023 (EP) 23174505.0

(51) Int. Cl. C08F 2/34; B01J 8/18; B01J 8/44; C08F 10/02

(52) U.S. Cl. CPC C08F 2/34; B01J 8/1827; B01J 8/44; C08F 10/02; B01J 2208/00716

(57) ABSTRACT

A process of starting up a gas phase olefin polymerization reaction carried out in the presence of a catalyst in a fluidized bed reactor, including the steps of: (a) flowing a gas composition, made from or containing an olefin, hydrogen and an inert gas, through the fluidized bed reactor; (b) activating the catalyst in a pre-contacting pot; (c) after the step of activating, feeding the catalyst into the fluidized bed reactor; and (d) (i) after the step of feeding the catalyst, monitoring the olefin concentration in the gas composition, (ii) when the olefin concentration drops, starting the feeding of the olefin into the fluidized bed reactor, (iii) controlling the olefin flow, thereby maintaining a concentration of olefin in the fluidized bed reactor within a given range.

### FIELD OF THE DISCLOSURE

In general, the present disclosure relates to the field of chemistry. More specifically, the present disclosure relates to polymer chemistry. In particular, the present disclosure relates to a process of starting up a gas phase olefin polymerization reaction.

### BACKGROUND OF THE DISCLOSURE

In some instances, gas-phase polymerization processes are used for the polymerization of olefins such as homopolymerizing ethylene or propylene or copolymerizing ethylene or propylene with other olefins. In some instances, gas-phase polymerizations are carried out in fluidized bed reactors, stirred gas-phase reactors or multizone circulating reactors with two distinct interconnected gas-phase polymerization zones. In some instances, the components in the gas-phase mixture are made from or containing monomers, alternatively further made from or containing comonomers. In some instances, the components in the gas-phase mixture are further made from or containing other gaseous components such as polymerization diluents, molecular weight modifiers, or low-molecular weight reaction products. In some instances, the polymerization diluents are nitrogen or alkanes. In some instances, the molecular weight modifier is hydrogen. In some instances, the resulting solid polyolefin particles are formed by polymerization catalyst systems. In some instances, the polymerization catalyst systems are made from or containing particulate catalyst solids.

In some instances, olefin gas-phase polymerization processes involve long start-up time, transition times, or both, thereby resulting in the loss of time and material. In some instances and during the start-up of reactors, the material used before producing the specified polymer is dissipated.

### SUMMARY

In a general embodiment, the present disclosure provides a process of starting up a gas phase olefin polymerization reaction.

### BRIEF DESCRIPTION OF THE DRAWINGS

The disclosure is hereinafter described with reference to the accompanying drawings, which depict some non-limiting embodiments thereof, wherein:

FIG. 1 shows a schematic and side view of a fluidized bed reactor.

FIG. 2 shows a schematic and side view of an arrangement including a fluidized bed reactor.

FIG. 3 shows a front cross-section of a detail of FIG. 1 and FIG. 2.

FIG. 4 shows a plan view of the part of the fluidized bed reactor of FIG. 1 and FIG. 2, with some details removed for clarity.

FIG. 5 shows a front cross-section of a detail of FIG. 4.

FIG. 6 shows a lateral cross-section of the detail of FIG. 4.

### DETAILED DESCRIPTION

In some embodiments, the present disclosure provides a process of starting up a gas phase olefin polymerization reaction carried out in the presence of a catalyst in a fluidized bed reactor.

Fluidized bed reactors are reactors, wherein the polymerization takes place in a bed of polyolefin particles maintained in a fluidized state by feeding in a reaction gas mixture at the lower end of a reactor and taking off the gas again at the top of the fluidized bed reactor. In some embodiments, the gas is fed below a gas distribution grid, having the function of dispensing the gas flow. The reaction gas mixture is then returned to the lower end of the reactor via a recycle line equipped with a centrifugal compressor and a heat exchanger, thereby removing the heat of polymerization. In some embodiments, the flow rate of the reaction gas mixture fluidizes the bed of finely divided polymer present in the polymerization zone and removes the heat of polymerization.

In some embodiments, multizone circulating reactors are as described in Patent Cooperation Treaty Publication Nos. WO 97/04015 A1 and WO 00/02929 A1. In some embodiments, multizone circulating reactors have two interconnected polymerization zones, a riser, wherein the growing polyolefin particles flow upward under fast fluidization or transport conditions, and a downcomer, wherein the growing polyolefin particles flow downward in a densified form under the action of gravity. The polyolefin particles leaving the riser enter the downcomer and the polyolefin particles leaving the downcomer are reintroduced into the riser, thereby establishing a circulation of polymer between the two polymerization zones. In some embodiments, the polymer is passed alternately a plurality of times through these two zones. In such polymerization reactors, a solid/gas separator is arranged above the downcomer to separate the polyolefin and reaction gaseous mixture coming from the riser. The growing polyolefin particles enter the downcomer. The separated reaction gas mixture of the riser is continuously recycled through a gas recycle line to one or more points of reintroduction into the polymerization reactor. In some embodiments, a major part of the recycle gas is recycled to the bottom of the riser. The recycle line is equipped with a centrifugal compressor and a heat exchanger, thereby removing the heat of polymerization. In some embodiments, a line for feeding catalyst or a line for feeding polyolefin particles coming from an upstream reactor is arranged on the riser. In some embodiments, a polymer discharge system is located in the bottom portion of the downcomer. In some embodiments, make-up monomers, comonomers, hydrogen, inert components, or combinations thereof are introduced at various points along the riser and the downcomer.

In some embodiments, olefins are polymerized in the gas-phase polymerization reactors. In some embodiments, the olefins are 1-olefins. As used herein, the term “1-olefins” refers to hydrocarbons having terminal double bonds, without being restricted thereto. In some embodiments, the olefins are nonpolar olefinic compounds. In some embodiments, the 1-olefins are linear C₂-C₁₂-1-alkenes, branched C₂-C₁₂-1-alkenes, conjugated dienes, or nonconjugated dienes. In some embodiments, the linear alkenes are linear C₂-C₁₀-1-alkenes. In some embodiments, the linear C₂-C₁₀-1-alkenes are selected from the group consisting of ethylene, propylene, 1-butene, 1-pentene, 1-hexene, 1-heptene, 1-octene, and 1-decene. In some embodiments, the branched alkenes are branched C₂-C₁₀-1-alkenes. In some embodiments, the branched C₂-C₁₀-1-alkene is 4-methyl-1-pentene. In some embodiments, the dienes are selected from the group consisting of 1,3-butadiene, 1,4-hexadiene, and 1,7-octadiene. In some embodiments, mixtures of various 1-olefins are polymerized. In some embodiments, the olefins have the double bond as part of a cyclic structure. In some embodiments, the cyclic structure has one or more ring systems. In some embodiments, the olefins, including a cyclic structure, are selected from the group consisting of cyclopentene, norbornene, tetracyclododecene, methylnorbornene, 5-ethylidene-2-norbornene, norbornadiene, and ethylnorbornadiene. In some embodiments, mixtures of two or more olefins are polymerized.

In some embodiments, the gas-phase polymerization reactors are for the homopolymerization or copolymerization of ethylene, propylene, or both, alternatively for the homopolymerization or copolymerization of ethylene. In some embodiments, comonomers in propylene polymerization are up to 40 wt. %, alternatively from 0.5 wt. % to 35 wt. %, of ethylene, 1-butene, 1-hexene, or combinations thereof, with respect to the total weight of the propylene copolymer, that is, the sum of the monomers and comonomers. In some embodiments, comonomers in ethylene polymerization are up to 20 wt. %, alternatively from 0.01 wt. % to 15 wt. %, alternatively from 0.05 wt. % to 12 wt. %, of C₃-C₈-1-alkenes, with respect to the total weight of the ethylene copolymer. In some embodiments, the alkenes are selected from the group consisting of 1-butene, 1-pentene, 1-hexene, 1-octene, and combinations thereof. In some embodiments, ethylene is copolymerized with from 0.1 wt. % to 12 wt. % of 1-hexene, 1-butene, or a combination thereof.

As used herein, unless otherwise specified, the term “Cx-Cy” refers to a group, a compound, or both, having x to y carbon atoms.

In some embodiments, the present disclosure provides a process including the steps of:
(a) flowing a gas composition, made from or containing an olefin, hydrogen and an inert gas, through the fluidized bed reactor 1, having a content of solid polymer particles lower than 1% of the maximum capacity of the fluidized bed reactor;
(b) activating the catalyst in a pre-contacting pot;
(c) after the step of activating, feeding the catalyst into the fluidized bed reactor; and
(d) (i) after the step of feeding the catalyst, monitoring the olefin concentration in the gas composition, (ii) when the olefin concentration drops, starting the feeding of the olefin into the fluidized bed reactor, and (iii) controlling the olefin flow, thereby maintaining a concentration of olefin in the fluidized bed reactor within a specified range, alternatively 4% to 25% molar, alternatively 6% to 15% molar, with respect to the gas content of the fluidized bed reactor.

In some embodiments, the molar concentration of the olefin in the fluidized bed reactor is measured by online Gas Chromatography (GC).

In some embodiments, the start-up of the polymerization is implemented on an empty fluidized bed reactor. As used herein, the term “empty” refers to the content of solid polymers being lower than 1% of the maximum capacity, alternatively lower than 0.5% of the maximum capacity.

As used herein and unless otherwise specified, the term “maximum capacity” refers to the volume of the cylindrical part of the fluidized bed reactor, wherein the height of the cylindrical part is measured from the uppermost part of the distribution grid.

In some embodiments, the actual weight of the fluidized bed is measured via pressure load on a pressure transmitter. In some embodiments, a DP cell is used. In some embodiments, the hold-up in place of capacity is used. In some embodiments, the fluidized bed reaches the maximum capacity. In some embodiments and for the measurement, at least two pressure transmitters are provided, wherein a first pressure transmitter is mounted at about the height of the fluidization grid. In some embodiments, a second pressure transmitter is mounted at a maximum height of the fluidized bed reactor, thereby permitting detection of the pressure difference between the upper part and the lower part. In some embodiments, the measurement is correlated to the weight of the fluidized bed. In some embodiments, intermediate pressure transmitters are mounted at intervals between the first pressure transmitter and the second pressure transmitter.

In some embodiments, the molar concentration of olefin in the fluidized bed reactor is measured by online Gas Chromatography (GC). In some embodiments, a sample of the gas mixture is channeled off from the recycle line between the compressor and the heat exchanger. In some embodiments, the sample is passed through a filter, thereby obtaining a clean sample free of entrained particles.

In some embodiments, the step of feeding the catalyst is carried out during the step of flowing, alternatively partially during the step of flowing.

In some embodiments the catalyst starts work immediately after getting to the reactor. In some embodiments and as the olefin concentration in the fluidized bed reactor is monitored via online gas chromatography, a drop in the olefin concentration is immediately recognized. In some embodiments, additional olefin is fed to the fluidized bed reactor, thereby compensating for the loss, the olefin concentration within a specified range, and leading to stable start-up conditions.

In some embodiments, the specified range is between 4% to 10% molar, alternatively between 6% to 10% molar, alternatively between 12% to 20% molar.

In some embodiments and during the step of flowing, the fluidized bed reactor reaches a predetermined inside temperature; alternatively an inside temperature of 20 to 200° C. In some embodiments and during the step of feeding, the fluidized bed reactor reaches a predetermined inside temperature; alternatively an inside temperature is of 20 to 200° C.

In some embodiments and during the step of flowing, the fluidized bed reactor reaches a predetermined inside pressure; alternatively an inside pressure of 0.5 to 100 MPa. In some embodiments and during the step of feeding, the fluidized bed reactor reaches a predetermined inside pressure; alternatively an inside pressure of 0.5 to 100 MPa.

In some embodiments and during the step of flowing, the gas composition flows through the fluidized bed reactor at a predetermined superficial gas velocity; alternatively a superficial gas velocity of 0.1 to 1 m/sec. In some embodiments and during the step of feeding, the gas composition flows through the fluidized bed reactor at a predetermined superficial gas velocity; alternatively a superficial gas velocity of 0.1 to 1 m/sec.

As used herein, the term “superficial gas velocity” refers to the gas velocity at the cylindrical part (that is, the part of the reactor 1 between the grid 3 and the velocity reduction zone 4) of the fluidized bed reactor. In some embodiments, the superficial gas velocity is measured by a flow transmitter located on the fluidization circuit (that is, recycle line 5). In some embodiments, the flow transmitter is located on the recycle line between the compressor and the heat exchanger.

In some embodiments and during the step of activating, the catalyst is inside the pre-contacting pot P, with an alkyl composition (alkyl stream). In some embodiments, there is more than one precontacting pot P.

In some embodiments, an alkyl stream (the alkyl composition) flows through the pre-contacting pot P, alternatively the fluidized bed reactor (for a predetermined time) before introducing the catalyst feed into the pre-contacting pot P. In some embodiments, the alkyl stream is made from or containing the alkyl composition.

In some embodiments, the risk of exposing the catalyst to unwanted substances is reduced, thereby preventing damage to the catalyst, preventing unwanted reactions, or both.

In some embodiments, the alkyl stream (the alkyl composition) flows through the pre-contacting pot P and the fluidized bed reactor for at least 20 minutes, alternatively at least 40 minutes, alternatively up to 90 minutes, alternatively up to 150 minutes, before introducing the catalyst feed into the pre-contacting pot P.

In some embodiments, the alkyl stream (alkyl composition) is made from or containing one or more organometallic compounds. In some embodiments, organometallic compounds are selected from the group consisting of lithium alkyls, magnesium alkyls, zinc alkyls, magnesium alkyl halides, aluminum alkyls, silicon alkyls, silicon alkoxides and silicon alkyl halides. In some embodiments, the organometallic compounds are selected from the group consisting of aluminum alkyls and magnesium alkyls. In some embodiments, the organometallic compounds are aluminum alkyls. In some embodiments, the organometallic compounds are trialkylaluminum compounds or compounds of this type wherein an alkyl group is replaced by a halogen atom. In some embodiments, the halogen atom is chlorine or bromine. In some embodiments, the aluminum alkyls are selected from the group consisting of trimethylaluminum, triethylaluminum, tri-isobutylaluminum, tri-n-hexylaluminum, diethylaluminum chloride, and mixtures thereof.

In some embodiments, TIBA and DEAC are fed to the pre-contacting pot at a ratio of 7:1 based on weight. In some embodiments, the ratio of TIBA+DEAC to catalyst is from 3.5:1 to 6.5:1, alternatively 5:1.

In some embodiments and during the step of activating, the catalyst has a residence time in the pre-contacting pot P between 10 to 100 minutes, alternatively 20 to 100 minutes; alternatively 20 to 60 minutes.

In some embodiments, at least two pre-contacting pots P and PP are provided and arranged in a series upstream the fluidized bed reactor. In some embodiments, the description of the pre-contacting pot P also applies to the pre-contacting pot PP. For example and in some embodiments, the description of the presence, the feeding, or both, of the alkyl stream (the alkyl composition) in reference to the pre-contacting pot P also applies to the pre-contacting pot PP.

In some embodiments, the activated catalyst is fed directly from the pre-contacting pots to the fluidized bed reactor. As used herein, the term “directly” refers to the absence of any polymerization reactor arranged between the pre-contacting pots and the fluidized bed reactor.

In some embodiments and during the step of feeding, the catalyst is fed to the fluidized bed reactor together with the alkyl stream (alkyl composition).

In some embodiments and after the catalyst is fed to the pre-contacting pot P for a predetermined time, an antistatic agent feed is introduced to the fluidized bed reactor. In some embodiments, the predetermined time is up to 60 minutes, alternatively up to 40 minutes. In some embodiments, the predetermined time is at least 5 min, alternatively at least 15 min.

In some embodiments, the antistatic agent feed is increased when a level of polyolefin particles in the fluidized bed reactor starts to increase.

In some embodiments, the bed level of polyolefin particles is measured by a DP cell transmitter.

In some embodiments, the antistatic agent is introduced in the fluidized bed reactor through one or more inlets (not depicted in the enclosed figures). In some embodiments, the inert gas is fed through the inlets before the antistatic agent, thereby reducing the risk of contaminants being present inside the reactor when the reactions start.

In some embodiments, the fluidized bed reactor has at least two inlets for the antistatic agent, wherein a first antistatic inlet is arranged proximate to a catalyst inlet 12 and a second antistatic inlet is arranged distal to the catalyst inlet 12.

In some embodiments, the two inlets for the antistatic agent are opposite to each other (that is, at 180° from each other with respect to a longitudinal axis of the fluidized bed reactor).

In some embodiments, the two inlets for the antistatic agent are located at a few centimeters, alternatively at least 4 centimeters, above the uppermost part of the distribution grid 3.

In some embodiments, the antistatic agent is fed through the second antistatic inlet distal to the catalyst inlet 12 after the predetermined time, without being fed through the first antistatic inlet proximate to the catalyst inlet 12. In some embodiments, the antistatic agent is also fed through the first antistatic inlet proximate to the catalyst inlet 12 after a predetermined bed weight is reached in the fluidized bed reactor.

In some embodiments, the bed weight is measured by the pressure load on a pressure transmitter (DP cell).

In some embodiments, the antistatic agent is made from or containing an alkoxyamine, a surfactant, or both. In some embodiments, the alkoxyamine is available commercially under the tradename Atmer™. In some embodiments, the alkoxyamine is Atmer163™. In some embodiments, the surfactant is PEK and available commercially from Clariant.

In some embodiments, the pressure inside the reactor 1 is gradually increased, alternatively to a predetermined set point, alternatively to a set point between 0.5 and 10 MPa, after feeding the catalyst into the reactor 1 and after the predetermined bed weight is reached.

In some embodiments, the gas composition is made from or containing between 2 to 20 mol-% of the olefin.

In some embodiments, the gas composition is made from or containing between 2 to 20 mol-% hydrogen.

In some embodiments, the inert gas is nitrogen or an alkane having from 1 to 10 carbon atoms. In some embodiments, the alkane is selected from the group consisting of methane, ethane, propane, n-butane, isobutane, n-pentane, isopentane, n-hexane, and mixtures thereof. In some embodiments, the inert gas is nitrogen or propane. In some embodiments, the inert gas is nitrogen or propane in combination with further alkanes. In some embodiments, the inert gas is a C₃-C₅ alkane, alternatively propane. In some embodiments, the inert gas is a C₃-C₅ alkane, alternatively propane, during the homopolymerization or copolymerization of ethylene.

In some embodiments, the present disclosure provides a method of preparing an olefin polymer including the step of: homopolymerizing an olefin or copolymerizing the olefin together with one or more other olefins at temperatures of from 20 to 200° C. and pressures of from 0.5 to 10 MPa in the presence of a polymerization catalyst, wherein the method has a start up phase. In some embodiments, the method is at least partly carried out in the fluidized bed reactor.

In some embodiments, the polymerization is a homopolymerization of ethylene or a copolymerization of ethylene and one or more other olefins selected from the group consisting of 1-butene, 1-hexene and 1-octene.

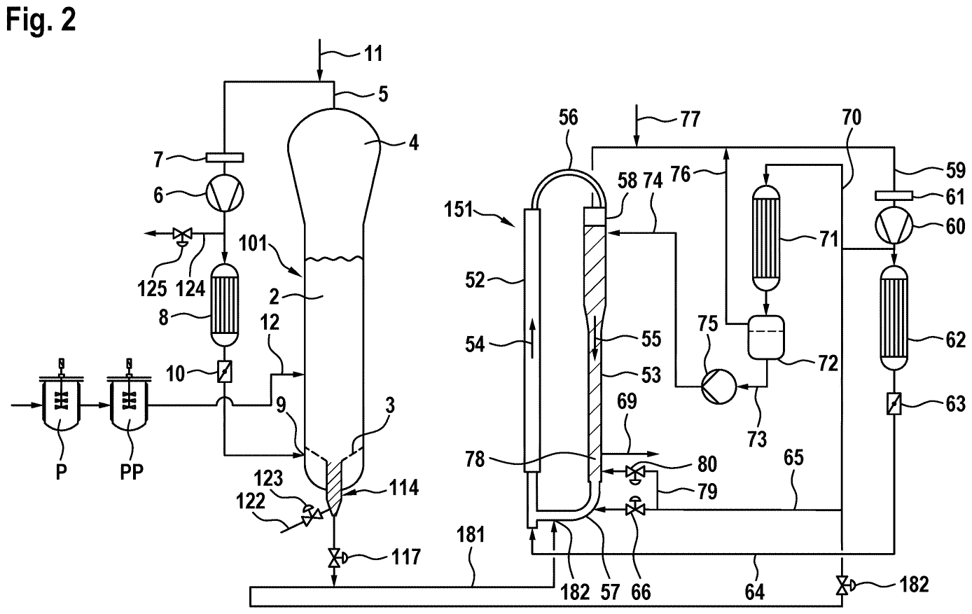

FIG. 2 shows a series of reactors 101 and 151. The series of reactors 101 and 151 include the fluidized bed reactor 101 and a multizone circulating reactor 151 arranged downstream of the fluidized bed reactor 101.

In some embodiments and while not shown herein, the series of reactors includes two fluidized bed reactors 1 and 101, wherein the second reactor is downstream of the first reactor.

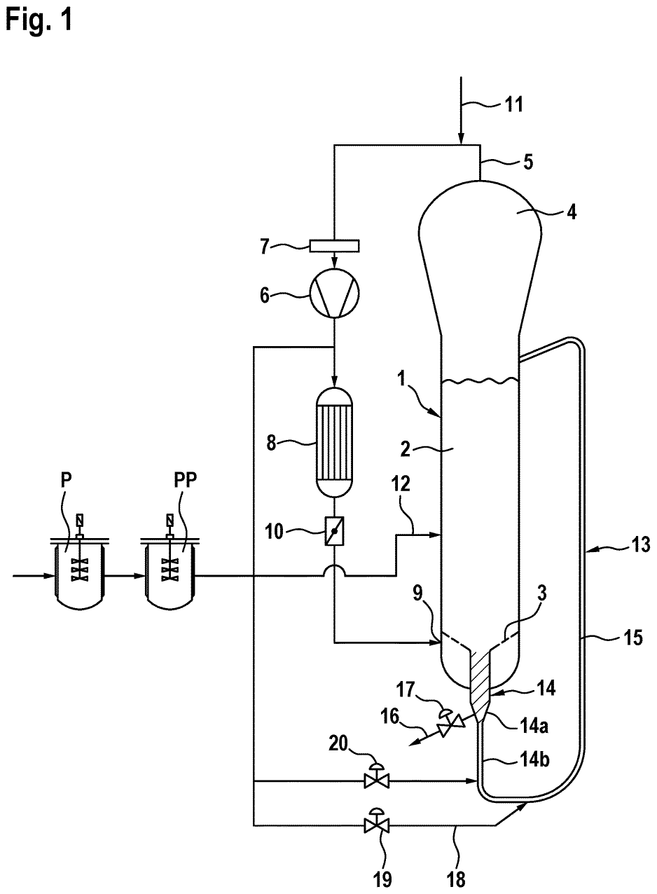

In some embodiments, the method is carried in a single fluidized bed reactor (FIG. 1).

In some embodiments, the resulting polyolefin is a high density polyethylene, having a density determined according to ISO 1183 at 23° C. from 0.945 to 0.970 g/cm³, or a low density polyethylene, having a density determined according to ISO 1183 at 23° C. from 0.915 to 0.944 g/cm³.

FIG. 1 shows a schematic of a fluidized bed reactor 1 and two pre-contacting pots P and PP.

The fluidized bed reactor 1 includes a fluidized bed 2 of polyolefin particles, a gas distribution grid 3 and a velocity reduction zone 4. In some embodiments, the velocity reduction zone 4 is of increased diameter compared to the diameter of the fluidized-bed portion of the reactor. An upwardly flow of gas fed through the gas distribution grid 3, placed at the bottom portion of the reactor 1, keeps the polyolefin bed in a fluidized state. The gaseous stream of the reaction gas leaving the top of the velocity reduction zone 4 via recycle line 5 is compressed by centrifugal compressor 6 having variable guide vanes 7, transferred to a heat exchanger 8, wherein the stream is cooled, and then recycled to the bottom of the fluidized bed reactor 1 at a point below the gas distribution grid 3 at position 9. In some embodiments and downstream of heat exchanger 8, the recycle line 5 further includes a butterfly valve 10. In some embodiments, make-up monomers, molecular weight regulators, and optional inert gases are fed into the reactor 1 at various positions, alternatively via line 11 upstream of the compressor 6. In some embodiments, the catalyst is fed into the reactor 1 via an inlet (a line) 12. In some embodiments, the inlet 12 is placed in the lower part of the fluidized bed 2.

In some embodiments, the fluidized bed reactor 1 is provided with a continuous pneumatic recycle of polyolefin particles by a circulation loop 13, connecting the gas distribution grid 3 to the upper region of the fluidized bed reactor 1. In some embodiments, the circulation loop 13 includes a settling pipe 14, which is integrated with the pipe's upper opening into the gas distribution grid 3. In some embodiments, the settling pipe 14 is arranged vertical. In some embodiments, the settling pipe 14 has a section of higher diameter 14a and a section of lower diameter 14b. In some embodiments, the gas distribution grid 3 has a cone shape such that cone's downward inclination towards the settling pipe 14 fosters the entry of the polyolefin particles into the settling pipe 14 due to gravity. In some embodiments, the upper opening of the settling pipe 14 is located in a central position with respect to the gas distribution grid 3. In some embodiments, the lower part of the settling pipe 14 is connected to a pneumatic conveyor pipe 15, which has the function of reintroducing the polyolefin particles into the fluidized bed reactor 1. In some embodiments, the outlet of the pneumatic conveyor pipe 15 is placed above the polymer bed 2 and below the velocity reduction zone 4.

The discharge of polyolefin particles from the fluidized bed reactor 1 occurs through discharge conduit 16, which is attached to the settling pipe section of higher diameter 14a. A control valve 17 is installed in discharge conduit 16 in proximity of settling pipe 14 for adjusting the flow rate of the polyolefin particles discharged from the fluidized bed reactor 1 into the discharge conduit 16. The discharge of the polyolefin particles is carried out continuously. The opening of the control valve 17 is adjusted, thereby maintaining the level of polyolefin particles constant inside the fluidized bed reactor 1.

In some embodiments, the control valve 17 is placed in the area of a restriction in the settling pipe 14 existing between the section of higher diameter 14a and the section of lower diameter 14b.

In some embodiments, the polyolefin particles not discharged through the discharge conduit 16 are recycled to the upper region of the fluidized bed reactor 1 by the circulation loop 13.

In some embodiments, the carrier gas for transporting the polyolefin particles through the pneumatic conveyor pipe 15 is taken from the gas recycle line at a point downstream of the compressor 6 and upstream of the heat exchanger 8, thereby exploiting the pressure drop existing through the heat exchanger 8, butterfly valve 10, the distribution grid 3 and the polymer bed 2. The carrier gas is predominantly fed via line 18 at the inlet of the conveyor pipe 15. The regulation of the flow rate of the polyolefin particles recycled through the circulation loop 13 is carried out by the control valves 19 and 20, thereby adjusting the flow rate of the carrier gas entering the conveyor pipe 15.

In some embodiments, the fluidized bed reactor 1 includes the gas distribution grid 3. In some embodiments, the gas distribution grid 3 is installed in a lower part of the fluidized bed reactor 1.

In some embodiments, the gas distribution grid 3 redirects the gas feed into a circumferential direction around a longitudinal axis of the fluidized bed reactor.

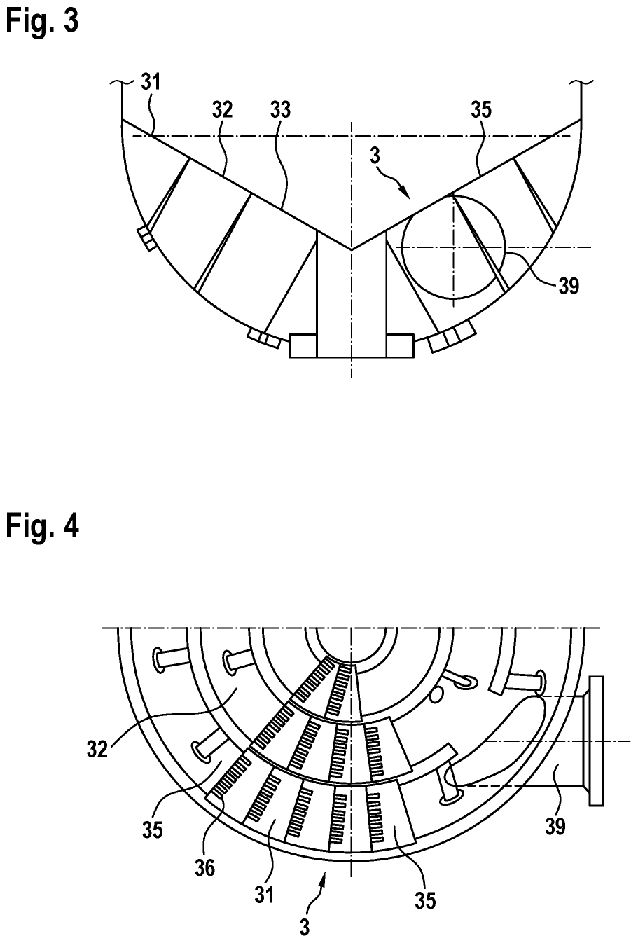

In some embodiments and as shown in FIG. 3-6, the gas distributor grid 3 includes three annular modules 31, 32, 33 of trays 35 connected to each other, thereby forming lateral walls of a truncated cone. In some embodiments, the annular modules 31, 32, 33 consist of trays 35 in form of plates mounted on annular supports such that each tray is connected with two adjacent trays. The annular modules are held supported by bars 30 protruding from the bottom wall of the reactor 1 below the gas distribution grid 3.

In some embodiments, grid 3 is provided with slots 36.

In some embodiments, the number of slots 36 increases from the inner to the peripheral annular module such that the number of slots per area is kept constant over the grid.

In some embodiments and as formed, the slots 36 provide a gas outlet, which is tangential at the plane of two adjacent trays 35, thereby the slots 36 generate a whirling, cyclonic motion of the gas stream above the gas distribution grid 3 mounted at the bottom of a fluidized bed reactor 1.

In some embodiments, the gas composition enters through a conduit 39 below the distribution grid 3 and having an inlet direction for causing a “centrifugal effect” in the zone underlying the distribution grid 3. Moreover, the flow of gas entering through the conduit 39 has the same orientation of the slots 36 on the distribution grid 3, thereby favoring the channeling of the gas into the slots 36.

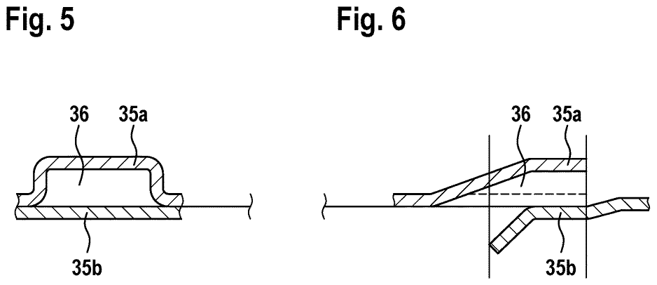

FIG. 5 shows a radial section of a single slot 36, that is, a section which is perpendicular to the direction of the gas flow passing through the slot 36.

In some embodiments, the slot 36 is formed by the overlapping of two adjacent trays 35a and 35b. Each tray forms on a side the lower part of the slots and on the opposite side the upper part of the slots. In some embodiments, the arrangement is identical for the trays in the gas distributor. In some embodiments, the upper end of the slot 36 is formed by a first tray 35a while the lower end of the slot 36 is formed by a second tray 35b fixed to the first tray 35a. In some embodiments, the first tray 35a forms slots 16 having a rectangular cross section. The first tray 35a defines the top and the sides of the rectangular slot 36 while the second tray 35b defines the bottom side of the rectangular slot 36. In some embodiments, the width of the slots 36 is more than the double of the slots' height.

FIG. 6 shows a tangential section of the slot 36, that is, a section oriented along the direction of the gas flow passing through the slot 36. In some embodiments, the upper part of the slot 36 is formed by a tray 35a while the lower part is formed by a successive tray 35b.

In some embodiments, the slots 36 consist of three portions along the flow direction: an inlet portion, a central portion and an outlet portion. In some embodiments and in the central portion, the trays 35a and 35b are parallel. In some embodiments, the length of the central portion is greater than the central portion's height. In some embodiments and with respect to the plane of the trays, the central portion's inclination is zero. In some embodiments, the inlet portion has a narrowing height along the flow direction while the outlet portion is slightly ascending and formed by the lower tray 35b. In some embodiments, the axes of the slots 16 are tangential with respect to the plane of the trays 35a, 35b.

FIG. 2 shows a schematic of a cascade of two serially connected gas-phase reactors 101 and 151 and two pre-contacting pots P and PP.

In some embodiments, the fluidized bed reactor 101 of FIG. 2 is similar to the fluidized bed reactor 1 of FIG. 1.

In some embodiments, the multizone circulating reactor 151 includes, as a first reaction zone, a riser 52 and, as a second reaction zone, a downcomer 53, which are repeatedly passed by the polyolefin particles. Within riser 52, the polyolefin particles flow upward under fast fluidization conditions along the direction of arrow 54. Within the downcomer 53, the polyolefin particles flow downward under the action of gravity along the direction of the arrow 55. The riser 52 and the downcomer 53 are interconnected by the interconnection bends 56 and 57.

After flowing through the riser 52, the polyolefin particles and the reaction gas mixture leave riser 52 and are conveyed to a solid/gas separation zone 58. In some embodiments, the solid/gas separation is effected by a centrifugal separator. In some embodiments, the centrifugal separator is a cyclone. From the separation zone 58, the polyolefin particles enter downcomer 53.

In some embodiments, the reaction gas mixture, leaving the separation zone 58, is recycled to the riser 52 by a recycle line 59, equipped with a centrifugal compressor 60 including variable guide vanes 61 and a heat exchanger 62. In some embodiments and downstream of heat exchanger 62, the recycle line 59 further includes a butterfly valve 63. Between the compressor 60 and the heat exchanger 62, the recycle line 59 splits and the gaseous mixture is divided into two separated streams. In some embodiments, line 64 conveys a first part of the recycle gas through the heat exchanger (62) and the butterfly valve 63 to the bottom of riser 52, thereby establishing fast fluidization conditions therein. In some embodiments, line 65 conveys a second part of the recycle gas into the interconnection bend 57. In some embodiments and for controlling the flow rate of the transport gas through line 65 into the interconnection bend 57, line 65 is equipped with a control valve 66.

In some embodiments, the polyolefin particles, obtained in the multizone circulating reactor 51, are continuously discharged from the bottom part of the downcomer 53 via the discharge line 69.

In some embodiments, part of the gaseous mixture leaving the separation zone 58 exits the recycle line 59 after having passed the compressor 60 and is sent through line 70 to the heat exchanger 71. In some embodiments, the part of the gaseous mixture is cooled to a temperature at which the monomers and the optional inert gas are partially condensed. A separating vessel 72 is placed downstream of the heat exchanger 71. The separated liquid is withdrawn from the separating vessel 72 via line 73 and fed to downcomer 53 through line 74 by a pump 75, thereby generating a barrier for preventing the reaction gas mixture of the riser 52 from entering the downcomer 53. The gaseous mixture obtained as gas-phase in the separating vessel 72 is recirculated to recycle line 59 through line 76. In some embodiments, make-up monomers, make-up comonomers, optionally inert gases, process additives, or a combination thereof are introduced into the recycle line 59 via line 77.

In some embodiments, the bottom of the downcomer 53 is equipped with a butterfly valve 78, having an adjustable opening for adjusting the flow of polyolefin particles from downcomer 53 through inter connection bend 57 into the riser 52. In some embodiments and above the butterfly valve 78, amounts of a recycle gas mixture, coming from the recycle line 59 through line 79, are introduced as dosing gas into the downcomer 53, thereby facilitating the flow of the polyolefin particles through butterfly valve 78. For controlling the flow rate of the dosing gas, line 79 is equipped with a control valve 80.

The fluidized bed reactor 101 differs from the fluidized bed reactor 1 in that the fluidized bed reactor 101 does not include a circulation loop 13. Instead, the settling pipe 114 is closed at the lower end by a discharge valve 117. In some embodiments, the discharge valve 117 is a segmental ball valve.

In some embodiments, the bed of polyolefin particles, contained in the settling pipe 114 during operation of fluidized-bed reactor 101, enters the settling pipe 114 at the upper opening, which is integrated into the gas distribution grid 3, and moves from top to bottom of the settling pipe. In some embodiments, discharge valve 117 is arranged above a line 181, which branches off the line 65 of the multizone circulating reactor 151 and carries a part of the recycle gas of multizone circulating reactor 151. In some embodiments and for controlling the flow rate of pick-up gas, alternatively recycle gas of the reactor 151 by which the polyolefin particles are transported, through line 181, line 181 is equipped with a control valve 182. In some embodiments, the polyolefin particles, having passed discharge valve 117, enter the line 181 and are transported by the pick-up gas to the multizone circulating reactor 151, wherein the polyolefin particles enter at a position near valve 182.

In some embodiments, the settling pipe 114 is further equipped with a line 121, thereby introducing a fluid that induces an upward stream of the fluid in the bed of polyolefin particles within the settling pipe 114 and preventing the reaction gas mixture of the fluidized bed reactor 101 from entering the line 181 and the multizone circulating reactor 151. In some embodiments, line 121 is at a position near the lower end of the settling pipe 114. The flow of the fluid in line 122 is controlled by a control valve 123. In some embodiments and to compensate for the part of the fluid introduced into settling pipe 114 through line 122 and enters the fluidized bed reactor 101 through settling pipe 114, a portion of the reaction gas within fluidized bed reactor 101 is withdrawn. In some embodiments, the withdrawal occurs through withdrawal line 124, which branches off recycle line 5 between the centrifugal compressor 6 and the heat exchanger 8. In some embodiments, the gas flow through withdrawal line 124 is controlled by a control valve 125. In some embodiments, the reaction gas withdrawn through line 124 is transferred to a work-up section (not shown in FIG. 2).

Unless expressly indicated to the contrary, the content of articles, books, and patent applications, etc. cited in this disclosure is recalled in full herein. In some embodiments, the cited documents are incorporated herein by reference.

The following description provides non-limiting examples, which are provided for illustrative purposes and are not intended to limit the scope of this disclosure.

### EXAMPLES

### Example 1—HDPE Start-Up

A fluidized bed reactor (FBR) was started up, without using a polymer bed (seed resin) for producing HDPE grade (MIE 2.19 kg at 190° C. 8-10 g/10′).

The reactor was preemptively brought at pressure of 3 MPa, with the following gas composition:

TABLE 1

| | Hydrogen | Ethylene | Propane |
|---|---|---|---|
| % molar | 6-8 | 6-8 | Rest (84-88) |

Reactor temperature was kept at 85° C. The superficial gas velocity, calculated as the gas velocity at the cylindrical part of the fluidized bed reactor (FBR), was kept at 0.4-0.7 m/s.

The cylindrical part, or polymerization area, had a diameter of 5.2 meters and a height of 21 meters.

For carrying out the polymerization, 5.5 kg/h of a solid Ziegler-Natta type catalyst were fed using 200 kg/h of liquid propane to a first stirred precontacting vessel, into which also a mixture of triisobutylaluminum (TIBA) and diethylaluminumchloride (DEAC) were dosed. The weight ratio between triisobutylaluminum and diethylaluminumchloride was 7:1. The ratio between aluminum alkyl to the solid catalyst was 5:1. The first precontacting vessel was kept at 50° C. with an average residence time of 35 minutes. The catalyst suspension of the first precontacting vessel was continuously transferred to a second stirred precontacting vessel, which was operated with an average residence time of 35 minutes and kept also at 50° C. Before feeding the catalyst to the first precontacting vessel, the mixture of triisobutylaluminum (TIBA) and diethylaluminumchloride (DEAC) was dosed for one hour. The catalyst suspension was then fed to the precontacting vessels and transferred continuously to fluidized bed reactor (FBR).

After 30 minutes from the catalyst feed to the precontacting vessels, an antistatic agent was fed to the fluidized bed reactor (FBR).

In fluidized bed reactor, ethylene was polymerized in the presence of propane as inert diluent while using hydrogen as a molecular weight regulator. The olefin concentration within the fluidized bed reactor was measured by online gas chromatography. Once the ethylene concentration in the fluidized bed reactor started to drop, ethylene was fed to the fluidized bed reactor. Ethylene was fed such that the ethylene molar percent in the fluidized bed reactor (FBR) did not exceed 10% and was no lower than 6%. Hydrogen was fed accordingly, thereby maintaining a Hydrogen/Ethylene molar ratio of 0.7-1.1. No comonomer was added. The polymerization was carried out at a temperature of 85° C. and a pressure of 3.0 MPa.

The fluidized bed reactor (FBR) polymer level was gradually increased up to a measured hold-up of about 60-70 tons.

The superficial gas velocity, measured at the cylindrical part of the fluidized bed reactor (FBR), was kept at 0.4-0.7 m/s. The polyethylene obtained in fluidized bed reactor had a MIE of 8 g/10 min and a density of 0.965 g/cm³.

The polyethylene obtained in fluidized bed reactor (FBR) was continuously transferred to a medium pressure filter, operating at 1.9 MPa, which continuously discharges to a finishing section.

### Example 2—HDPE Start-Up

A fluidized bed reactor (FBR) was started up, without using a polymer bed (seed resin) for producing HDPE grade (MIE 2.19 kg at 190° C. 8-10 g/10′).

The reactor was preemptively brought at pressure of 3 MPa, with the following gas composition:

TABLE 2

| | Hydrogen | Ethylene | Propane |
|---|---|---|---|
| % molar | 6-8 | 6-8 | Rest |

Reactor temperature was kept at 85° C. The superficial gas velocity, calculated as the gas velocity at the cylindrical part of the fluidized bed reactor (FBR), was kept at 0.3-0.5 m/s.

The cylindrical part, or polymerization area, had a diameter of 0.8 meters and a height of 3.65 meters.

For carrying out the polymerization, 30 g/h of a solid Ziegler-Natta type catalyst were fed using 30 kg/h of liquid propane to a first stirred precontacting vessel, into which also a mixture of triisobutylaluminum (TIBA) and diethylaluminumchloride (DEAC) were dosed. The weight ratio between triisobutylaluminum and diethylaluminumchloride was 7:1. The ratio between aluminum alkyl to the solid catalyst was 5:1. The first precontacting vessel was kept at 50° C. with an average residence time of 40 minutes. The catalyst suspension of the first precontacting vessel was continuously transferred to a second stirred precontacting vessel, which was operated with an average residence time of 40 minutes and kept also at 50° C. Before feeding the catalyst to the first precontacting vessel, the mixture of triisobutylaluminum (TIBA) and diethylaluminumchloride (DEAC) was dosed for one hour. The catalyst suspension was then fed to the precontacting vessels and transferred continuously to fluidized bed reactor (FBR).

After 30 minutes from the catalyst feed to the precontacting vessels, an antistatic agent was fed to the fluidized bed reactor (FBR).

In fluidized bed reactor, ethylene was polymerized in the presence of propane as inert diluent while using hydrogen as a molecular weight regulator. The olefin concentration within the fluidized bed reactor was measured by online gas chromatography. Once the ethylene concentration in the fluidized bed reactor started to drop, ethylene was fed to the fluidized bed reactor. Ethylene was fed such that the ethylene's molar percent in the fluidized bed reactor (FBR) did not exceed 10% and was no lower than 4%. Hydrogen was fed accordingly, thereby maintaining a Hydrogen/Ethylene molar ratio of 0.7-1.1. No comonomer was added. The polymerization was carried out at a temperature of 85° C. and a pressure of 3.0 MPa.

The fluidized bed reactor (FBR) polymer level was gradually increased up to a measured hold-up of about 300 kg.

The superficial gas velocity, measured at the cylindrical part of the fluidized bed reactor (FBR), was kept at 0.3-0.5 m/s. The polyethylene obtained in fluidized bed reactor had a MIE of 8 g/10 min and a density of 0.965 g/cm³.

The polyethylene obtained in fluidized bed reactor was continuously transferred to a medium pressure filter, operating at 1.9 MPa, which continuously discharges to a finishing section.

### Example 3—LLDPE Start-Up

A fluidized bed reactor (FBR) was started up without using a polymer bed (seed resin) for producing LLDPE grade (MIE 2.19 kg at 190° C. 2 g/10′).

The reactor was preemptively brought at pressure of 2.2 MPa, with the following gas composition:

TABLE 3

| | Hydrogen/ | | Comonomer/ | |
|---|---|---|---|---|
| | Ethylene | Ethylene | (Comonomer + Ethylene) | Propane |
| % molar | 0.3-0.4 | 14-18% | 0.1-0.12 (1-Hexene) | Rest |

Reactor temperature was kept at 86° C. The superficial gas velocity, calculated as the gas velocity at the cylindrical part of the fluidized bed reactor (FBR), was kept at 0.3-0.5 m/s.

The cylindrical part, or polymerization area, had a diameter of 0.8 meters and a height of 3.65 meters.

For carrying out the polymerization, 18 g/h of a solid Ziegler-Natta type catalyst were fed using 30 kg/h of liquid propane to a first stirred precontacting vessel, into which also trihexylaluminum (THA) was dosed. The weight ratio between trihexylaluminum (THA) and catalyst was 0.33. The first precontacting vessel was kept at 40° C. with an average residence time of 150 minutes. The catalyst suspension of the first precontacting vessel was continuously transferred to a second stirred precontacting vessel, into which also diethylaluminumchloride (DEAC) and triethylaluminum (TEAL) were dosed. The weight ratio diethylaluminumchloride (DEAC) to catalyst was 0.25 while the ratio of triethylaluminum (TEAL) to catalyst was 0.2. The second precontacting vessel was operated with an average residence time of 47 minutes and kept also at 40° C. Before feeding the catalyst to the first precontacting vessel, trihexylaluminum (THA) and the mixture of diethylaluminumchloride (DEAC) and triethylaluminum were dosed for one hour. The catalyst suspension was then fed to the precontacting vessels and transferred continuously to fluidized bed reactor (FBR).

No antistatic agent was fed to the fluidized bed reactor (FBR).

In fluidized bed reactor, ethylene was polymerized in the presence of propane as inert diluent while using hydrogen as a molecular weight regulator. The olefin concentration within the fluidized bed reactor was measured by online gas chromatography. Once the ethylene concentration in the fluidized bed reactor started to drop, ethylene was fed to the fluidized bed reactor. Ethylene was fed such the ethylene's molar percent in the fluidized bed reactor (FBR) did not exceed 20% and was no lower than 12%. Hydrogen was fed to maintain a Hydrogen/Ethylene molar ratio of 0.3-0.4. As comonomer, 1-Hexene as used. The polymerization was carried out at a temperature of 86° C. and a pressure of 2.2 MPa.

The fluidized bed reactor (FBR) polymer level was gradually increased up to a measured hold-up of about 250 kg.

The superficial gas velocity, measured at the cylindrical part of the fluidized bed reactor (FBR), was kept at 0.3-0.5 m/s. The polyethylene obtained in fluidized bed reactor had a MIE of 2 g/10 min and a density of 0.918 g/cm³.

1. A process of starting up a gas phase olefin polymerization reaction carried out in the presence of a catalyst in a fluidized bed reactor, comprising the steps of:
(a) flowing a gas composition, comprising an olefin, hydrogen and an inert gas, through the fluidized bed reactor having a content of solid polymer particles lower than 1% of the maximum capacity of the fluidized bed reactor;
(b) activating the catalyst in a pre-contacting pot;
(c) after the step of activating, feeding the catalyst into the fluidized bed reactor; and
(d) (i) after the step of feeding the catalyst, monitoring the olefin concentration in the gas composition,
(ii) when the olefin concentration drops, starting the feeding of the olefin into the fluidized bed reactor, and
(iii) controlling the olefin flow, thereby maintaining a concentration of olefin in the fluidized bed reactor within a specified range.

2. The process of claim 1, wherein, during the step of flowing, the fluidized bed reactor has an inside temperature of 20 to 200° C. and an inside pressure of 0.5 to 100 MPa and the gas composition flows through the fluidized bed reactor at a superficial gas velocity of 0.1 to 1 m/sec.

3. The process of claim 1, wherein the fluidized bed reactor comprises a gas distribution grid installed in a lower part of the fluidized bed reactor and the gas distribution grid redirects the gas feed into a circumferential direction around a longitudinal axis of the fluidized bed reactor.

4. The process of claim 1, wherein before introducing the catalyst feed into the pre-contacting pot, an alkyl stream flows through the pre-contacting pot and the fluidized bed reactor.

5. The process of claim 1, wherein during the step of activating, the catalyst has a residence time in the pre-contacting pot between 10 to 100 min.

6. The process of claim 1, wherein at least two pre-contacting pots are provided and are arranged in a series upstream the fluidized bed reactor.

7. The process of claim 1, wherein; after the catalyst is fed to the pre-contacting pot for a predetermined time, an antistatic agent is introduced to the fluidized bed reactor.

8. The process of claim 7, wherein the fluidized bed reactor comprises at least two inlets for the antistatic agent, wherein a first antistatic inlet being arranged proximate to a catalyst inlet and a second antistatic inlet being arranged distal to the catalyst inlet and the antistatic agent being fed through the second antistatic inlet distal to the catalyst inlet after the predetermined time, without being fed through the first antistatic inlet proximate to the catalyst inlet.

9. The process of claim 1, wherein an antistatic agent is introduced in the fluidized bed reactor through one or more inlets and the inert gas is fed through the inlets before the antistatic agent.

10. The process of claim 1, wherein the pressure is gradually increased to a predetermined set point after feeding the catalyst into the fluidized bed reactor.

11. The process of claim 1, wherein the gas composition comprises between 2 to 20 mol-% olefin.

12. A method of preparing an olefin polymer comprising the step of:
homopolymerizing an olefin or copolymerizing the olefin together with one or more other olefins at temperatures of from 20 to 200° C. and pressures of from 0.5 to 10 MPa in the presence of a polymerization catalyst, wherein the method comprises a start up phase according to the process of claim 1.

13. The method according to claim 12, wherein the polymerization is a homopolymerization of ethylene or a copolymerization of ethylene and one or more other olefins selected from the group consisting of 1-butene, 1-hexene and 1-octene.

14. The method according to claim 13, wherein the resulting polyolefin is a high density polyethylene, having a density determined according to ISO 1183 at 23° C. from 0.945 to 0.970 g/cm³, or a low density polyethylene, having a density determined according to ISO 1183 at 23° C. from 0.915 to 0.944 g/cm³.

15. The method according to claim 12, wherein a series of reactors is provided, comprising the fluidized bed reactor and a multizone circulating reactor arranged downstream of the fluidized bed reactor.
